(19) United States
(12) Patent Application Publication
(10) Pub. No.: US 2005/0182700 A1
(43) Pub. Date: Aug. 18, 2005

(54) Method and system for processing activity information of business organization

(76) Inventor: Won-Kyo Suh, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/511,474

(22) PCT Filed: Apr. 16, 2003
(86) PCT No.: PCT/KR03/00772

(30) Foreign Application Priority Data
Apr. 17, 2002 (KR) 10 2002 0020848

(51) Int. Cl. G06F 17/60

(52) U.S. Cl. 705/32

(57) ABSTRACT

An activity information processing system of a business organization stores an activity information definition table matched with activity information, and makes an activity report based on input activity information and a corresponding account of an activity report. To achieve this, a plurality of activity types for respectively defining an activity history of the business organization is displayed. When a user selects at least one of the displayed activity types, a configuration screen matched with “what” and “how” of the activity types is displayed so as to input activity information on the selected activity type. When the user inputs activity information, it is determined whether it is an external activity or an internal activity, a corresponding activity result and an activity information definition table are used to process activity information, and the processed activity information is used to provide an activity report on the activity of the business organization.

### CROSS REFERENCE TO RELATED APPLICATION

This application is based on Korea Patent Application No. 2002-20848 filed on Apr. 17, 2002 in the Korean Intellectual Property Office, the content of which is incorporated herein by reference.

### BACKGROUND OF THE INVENTION

(a) Field of the Invention

The present invention relates to a method and system for processing activity information of a business organization. More specifically, the present invention relates to a method and system for processing activity information of a business organization for providing activity reports generated in a business organization to a plurality of users in real-time.

(b) Description of the Related Art

In general, when a company starts activities, accounting information is formulated as accounting reports through an accounting process, and non-accounting information is collated as other types of reports through a separate process, from among various categories of information on business activities.

In order to make the respective reports, necessary accounting information and non-accounting information is externally input or directly written, and a system for executing the above-noted process is disparately separated because the principles for processing both types of information are different.

Traditionally, since accounting information undergoes a journalizing process, it is processed following a journalizing principle. That is, as shown in FIG. 1, by allocating corresponding items of an account and price into a journalizing frame of artificially composed creditor and debtor, the accounting information is processed, which generates inconveniences of learning the journalizing principle.

FIG. 1 shows an information process of journalizing accounting.

As shown, according to the conventional accounting process using journalizing, information that is not caught through the journalizing cannot be processed; cash flow information, business values information and cost information based on activities information cannot be provided; and in the case of governmental or nonprofit organizations, it is impossible to provide individual accounting reports of bookkeeping by the single entry such as revenue and expenditure reports on final accounts.

To improve the drawbacks of learning the journalizing principle from among the problems of the journalizing accounting, an automatic journalizing method has recently been proposed to obtain some quickness of accounting processing, but the essential problems have not yet been solved because of a failure to overcome the original journalizing frame system in the accounting process.

To fundamentally improve the problems of journalizing accounting, U.S. Pat. No. 6,330,545 entitled “Activity Information Accounting Method and System” has been disclosed, which will be described with reference to a drawing.

FIG. 2 shows an information processing flowchart of activity information accounting for improving the problems of journalizing accounting.

The process allows accounting processing by matching an activity value and a resource value on the common sense basis without learning artificial matching logic of the creditor and the debtor. The above-noted activity information accounting provides improved reports in some points, but it only provides a method for composing accounting reports, and it requires separate preparation of non-accounting reports needed by a corresponding organization through an additional process.

Differing from the preparation principle of the accounting reports, the method for composing non-accounting reports does not use a method for matching the debtor with the creditor or matching the activity value with the resource value, but it directly collects necessary information on the activities of a matched organization (or a company) in various ways, and provides the same. That is, the composition of non-accounting reports requires no additional processing principle.

As described above, since accounting information and non-accounting information are not processed by a single processing principle, the process for obtaining information necessary for decision making by the corresponding organization becomes dual. Accordingly, it is difficult to build an accounting and non-accounting processing system in the case of the conventional organization activity processing system that uses a great deal of time for providing information, is costly, and provides incomplete information.

### SUMMARY OF THE INVENTION

It is an advantage of the present invention to provide an activity information processing method and system for providing activity reports including accounting reports and non-accounting reports related to various activities in a business organization in real-time.

It is another advantage of the present invention to provide an activity information processing method and system in the business organization for providing the activity reports using a single system that allows a journalizing information input method or an activity information input method, thereby providing a convenient activity information processing service to users who are experienced with the conventional accounting processing.

It is still another advantage of the present invention to provide an activity information processing method and system in the business organization for converting accounting data processed by the journalizing accounting processing system or the activity accounting processing system into the activity information data format according to a preferred embodiment of the present invention, to thereby maintain the continuous use of activity information.

In one aspect of the present invention, a method for processing activity information of a business organization using a data processing system for storing an activity information definition table matched with activity information and making an activity report based on input activity information and a corresponding account of the activity report, comprises: (a) respectively displaying a plurality of activity types respectively defining an activity history of the business organization; (b) receiving a selection of at least one activity type of the displayed activity types from a user; (c) displaying a configuration screen corresponding to “what” and “how” of the activity type so as to input activity information on the selected activity type; (d) using the activity information input by the user and the activity information definition table, and processing activity information; and (e) using the processed activity information and providing an activity report on the activity of the business organization.

The (c) comprises displaying a configuration screen of the 5W1H rule additionally including “who,” “when,” “where,” and “why” of the activity type.

In another aspect of the present invention, a method for processing activity information of a business organization using a data processing system for making an activity report based on activity information extracted from a first database and a second database, and an account of an activity report corresponding to the activity information, the first database storing an activity information definition table matched with activity information of the business organization and managing information on accounting of the business organization, the second database managing information on non-accounting aspects of the business organization, 5 comprises: (a) extracting account item information matched with the debtor and the creditor of the business organization from the first database, referring to the activity information definition table, and acquiring first activity information matched with the extracted information; (b) extracting information matched with additional activity information except the first activity 10 information from the second database, referring to the activity information definition table, and acquiring second activity information matched with the extracted information; (c) combining the acquired first and second activity information, using the combined activity information and the activity information definition table, and processing activity information; and (d) using is the processed activity information, and providing an activity report on the activity of the business organization.

In still another aspect of the present invention, an activity information processing system comprises: a secondary memory for storing an activity information definition table matched with activity information of a 20 business organization, and storing an activity information processing program and activity information processing results, the activity information processing program processing activity information based on a connection relation between the input activity information and a corresponding activity report; an output device for outputting a plurality of activity types for respectively defining an activity history of the business organization so that a user may select at least one of the output activity types, and outputting a configuration screen matched with “what” and “how” of the activity types so that activity information on the selected activity type may be input; and a CPU (central processing unit) for using the stored activity information definition table, and providing an activity report on the activity of the business organization.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a conventional information process of journalizing accounting;

FIG. 2 shows a conventional information process of activity accounting;

FIG. 3 shows an activity information processing system in a business organization according to a first preferred embodiment of the present invention;

FIG. 4 shows a brief operation flowchart of an activity information processing system in a business organization according to a preferred embodiment of the present invention;

FIG. 5 shows a detailed flowchart of a step S130 for processing activity information, and a step S140 for outputting an activity report in the operation process of the activity information processing system shown in FIG. 4;

FIG. 6 shows an exemplified activity information database stored in an activity information database of the activity information processing system in the business organization according to a preferred embodiment of the present invention;

FIGS. 7(a) and 7(b) show exemplified activity information definition tables according to a preferred embodiment of the present invention;

FIG. 8 shows an exemplified activity information definition table according to a preferred embodiment of the present invention, that is, a table for defining a machine driving activity from among internal activities;

FIG. 9 shows an exemplar for recording activity information according to a preferred embodiment of the present invention, that is, activity information of a machine driving activity from among the internal activities;

FIGS. 10 through 12 show an internal activity and cost accounting process;

FIG. 13 shows an exemplified business value report made according to a preferred embodiment of the present invention;

FIG. 14 shows a list of various activity reports according to a preferred embodiment of the present invention;

FIGS. 15(a) and 15(b) show flowcharts of an activity information input process according to input methods when processing the journalizing accounting or the activity accounting in the conventional information system divided into an accounting system and a non-accounting system;

FIGS. 16(a) and 16(b) show a process for converting externally input journalizing or activity accounting data in the conventional information system, divided into an accounting system and a non-accounting system, into activity information data according to a preferred embodiment of the present invention;

FIG. 17 shows a configuration of an activity information processing system in a business organization according to a second preferred embodiment of the present invention; and

FIG. 18 shows a configuration of an activity information processing system in a business organization according to a third preferred embodiment of the present invention.

### DETAILED DESCRIPTION OF THE PREFERRED EMBODIMENTS

In the following detailed description, only the preferred embodiments of the invention have been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

For ease of description, a profit-making organization and a nonprofit-making organization will not be distinguished; an organization that operates using economic resources will be referred to as a business organization; various reports that are needed by the business organization for reasonable decision making will be referred to as activity reports; and various categories of accounting concepts including financial accounting, management accounting, bookkeeping by the single entry, bookkeeping by the double entry, profit-making accounting, nonprofit-making accounting, business accounting, governmental accounting, journalizing accounting, and activity accounting will be unified as a single accounting concept, as well as accounting information and non-accounting information.

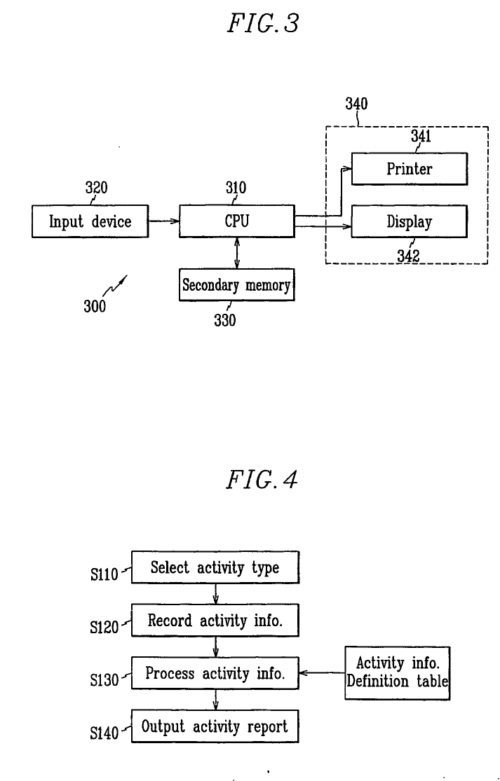

FIG. 3 shows an activity information processing system in a business organization according to a first preferred embodiment of the present invention.

Referring to FIG. 3, the activity information processing system 300 in the business organization comprises a CPU (central processing unit) 310, an input device 320, a secondary memory 330, and an output device 340 which includes a printer 341 and a display 342.

The CPU 310 reads and executes program instructions for processing information on activities of the business organization, and comprises a ROM (read only memory) and a RAM (random access memory) which are storage devices for data processing.

The input device 320 allows a user to input business organization activity data, and comprises a mouse and a keyboard. The output device 340 displays data processing results according to the activity information processing method according to a preferred embodiment of the present invention, and comprises a printer 341 and a display 342.

The secondary memory 330 stores programs for executing the activity information processing method, and stores activity information processing results as a predetermined file format.

An operation of the activity information processing system of the business organization having the above-described configuration will be described in detail with reference to a drawing.

FIG. 4 shows a brief operation flowchart of an activity information processing system in a business organization according to a preferred embodiment of the present invention.

Referring to FIG. 4, when an activity is generated from the business organization, a user may select an activity type through the input device 320 of the activity information processing system 300 in step S110.

That is, when an activity is generated from the business organization, the user operates the activity information processing system 300 to select the type of generated activity, and in this case, the display 342 of the activity information processing system 300 according to the preferred embodiment of the present invention displays an activity type including one of a purchase and acquisition activity, a sale and income activity, an expense activity, and a production activity in the case of a business division in the business organization, and it also displays an activity type of one of a revenue activity, an expenditure activity, and an administration service providing activity in the case of a governmental division. The activity types of the business division and the governmental division belong to the preferred embodiment, and without being restricted to this, their classification and names may be differentiated depending on the business organization, which shows that the present invention does not aim at classification and names of the activities, but aims at processing the activity information through the method of selecting an activity type.

In the preferred embodiment of the present invention, the above-noted activity types are classified as an external activity, an internal activity, and a closing activity.

The external activity includes an activity that accompanies transactions between a business organization and an organization external to the business organization. The external activity includes a purchase and acquisition activity, a sale and income activity, an expense activity, and an investment and financial activity in the case of the non-governmental section, and it includes a revenue activity and an expenditure activity in the case of the governmental section.

The internal activity represents an activity for the business organization to use resources obtained through an external activity (i.e., a production activity and an administration service providing activity) and process the same inside the business organization.

The closing activity, which is required by the technical reasons of information processing, indicates an activity for collectively recording resource consumption and others at the settling term of activity information processing, and it is not an everyday activity.

The above-noted activity types can be understood and selected by any normal person with common sense, and those who work at the business organizations can easily know the types without particular expertise.

After this, the user inputs detailed activity information on the corresponding activity type through the input device 320 in step S120. In detail, when the user selects one of the activity types displayed on the display 342, the activity information processing system according to the preferred embodiment of the present invention displays corresponding contents through the display 342 so as to input further detailed activity information on the selected activity, and the user inputs appropriate data matched with the displayed contents in a numerical or character format through the input device 320.

In this instance, the data input through the input device 320 represent the 5W1H, that is, who, when, where, what, how, and why related to the generated activity.

In further detail, the activity information input by the user includes a position and a name (who) of a man in charge who has executed the activity, an activity execution date (when), an activity execution place or a business connection (where), an activity name, an activity's product, and an activity value (what), a resource name and a resource value (how), and an activity's execution foundation (why).

As described, when an activity occurs in the business organization, the user selects to which activity type the corresponding activity corresponds in step S110, and simply inputs numerical or character data needed for the selected activity according to the contents displayed on the display 342 in step S120, thus finishing the data input process according to the preferred embodiment of the present invention.

The input process can be performed through a manual manipulation, or by automatically referring to necessary data when the data are previously input by various secondary systems currently used.

In the preferred embodiment of the present invention, the very commonsense economic phenomena that the activities of the business organization have their own values and they need corresponding resources so as to perform the activities, and that the corresponding activity value and the resource value are equivalent, are reflected to the activity information processing method, and this is also applied to the external activities and internal activities in the same manner.

In this instance, the activity value represents a value for the activity itself, and the resource value indicates a value of the resource for enabling the activity.

However, the activity value and the resource value are displayed as a price in currency in the case of external activities generated by a transaction with the external side of the business organization, and the internal activity for creating added values by using the externally provided resources is generally displayed not in the price but in the quantity when the 5 activity has just been generated.

For example, assuming that a user sells a product A for one million Won (Korean currency), receives 600,000 Won in cash, and leaves 400,000 Won on credit in the external activity case, the activity name is a sale activity, the activity product is the product A, the activity value is one million Won, the resource names are respectively the cash and the account receivable, and the corresponding resource values are respectively 600,000 Won and 400,000 Won.

The above-noted activity is matched with an internal activity case in which 9 units of the product A are produced through a production plan, and a worker in charge of this has worked 1,000 hours and the power of 50,000 Kw/h has been used. The worker in charge who works for the internal activities can input the internal activity information without additional learning in the like manner of the external activities.

After this, the activity information processing system 300 of the business organization uses a predetermined information processing program stored in the secondary memory 330 to process the externally input activity information in step S130.

The activity information processing system 300 determines whether the activity information input by the user is an external activity or an internal activity, and performs predetermined activity processing on the activity referring to an activity information definition table previously provided.

After this, the activity information processing system 300 outputs an activity report according to an activity information processing result in step S140. The activity report includes: accounting reports comprising a per-product cost report, an income statement, a business value report, a revenue and expenditure settlement statement, a balance sheet, and a cash flow statement; and non-accounting reports comprising personal resume information, a stock receipt and payment report, a production completion report, and a per-order-sheet delivery report.

In this instance, the step S130 of processing activity information and the step S140 of outputting an activity report from among the steps of the operation of the activity information processing system of the business organization according to the preferred embodiment of the present invention will now be described in detail with reference to a drawing.

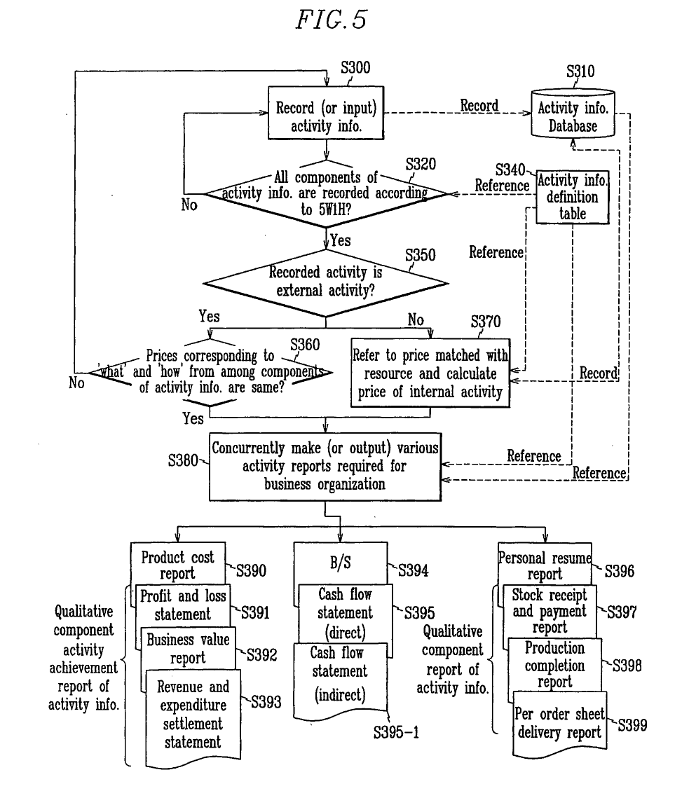

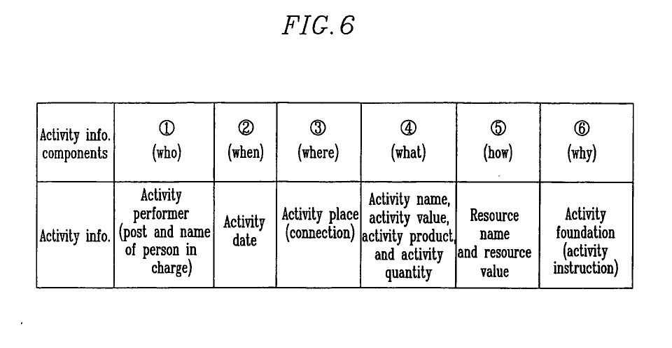

FIG. 5 shows a detailed flowchart for the step S130 of processing activity information and the step S140 of outputting an activity report from among the steps of the operation of the activity information processing system.

Referring to FIG. 5, when externally receiving activity information through a user in step S300, the activity information processing system 300 stores activity information in an activity information database in step S310, and checks whether components of the externally input activity information have all been recorded in step S320.

As shown in FIG. 6, the components of activity information include the six components of the 5W1H of when, where, who, what, why, and how, used for accurately recording matters and situations without missing them, and in detail, they include a position and a name (who) of a man in charge who has executed the activity; an activity execution data (when); an activity execution place or a business connection (where); an activity name, an activity's product, and an activity value (what); a resource name and a resource value (how), and an activity's execution foundation (why).

In this instance, the activity value and the resource value are respectively matched with “what” and “how,” and the give-and-take process in the real transaction is equivalent in its principle, and when it is not so, the transaction does not hold good and fails to generate the activity, and hence the activity value and the resource value are the same.

After this, the activity information processing system 300 checks whether all the components of the activity information have been recorded to determine whether the recorded activity is an external activity or an internal activity in step S350. When the input activity information is found to be an external activity according to the determination result, it determines whether the price of the activity value (what) is the same as that of the resource value (how) in step S360, and when they are found to be different, a message for allowing a user to again input the activity information is output.

However, when the input activity information is an internal activity according to the determination result, it checks the price matched with the resource corresponding to the internal activity by referring to the activity information definition table to thereby calculate the price of the internal activity in step S370.

Since the internal activity in the business organization indicates a step for processing the resource obtained through an external activity, it is required to refer to the price of the product of the external activity matched with the resource used for the internal activity so as to calculate the price of the resource used for the internal activity.

The price calculation of the internal activity according to the preferred embodiment of the present invention corresponds to the cost accounting of the internal activity that is a conventional accounting processing method. Also, since the value of the product of the activity matched with the resource according to the 5W1H rule is displayed not as the price but as the quantity, it is required to display the quantity as the price, and the step of S370 is the process for calculating the price.

Here, the activity information definition table used in the preferred embodiment of the present invention, and an activity information process using the same will now be described in detail with reference to drawings.

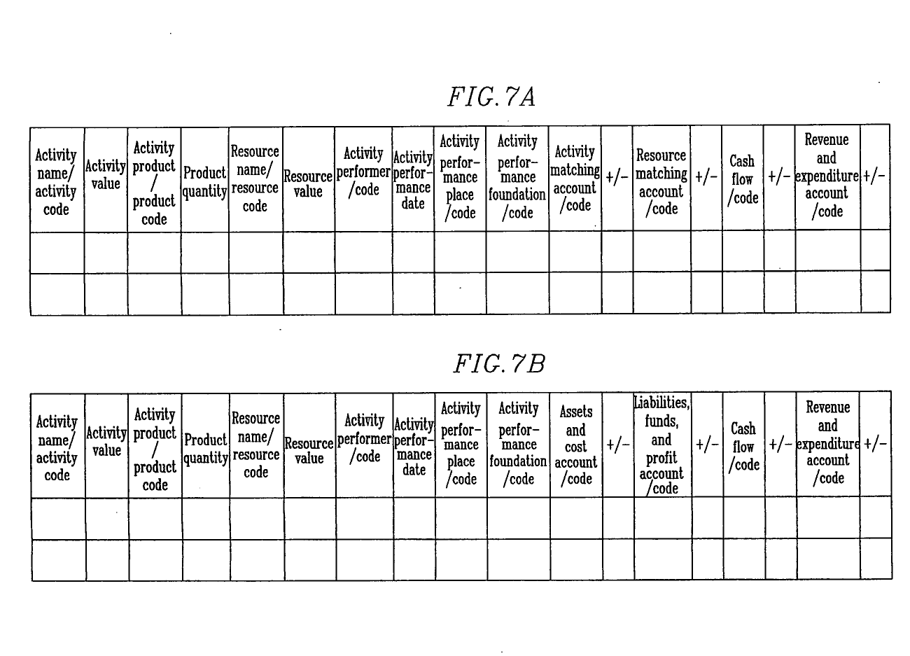

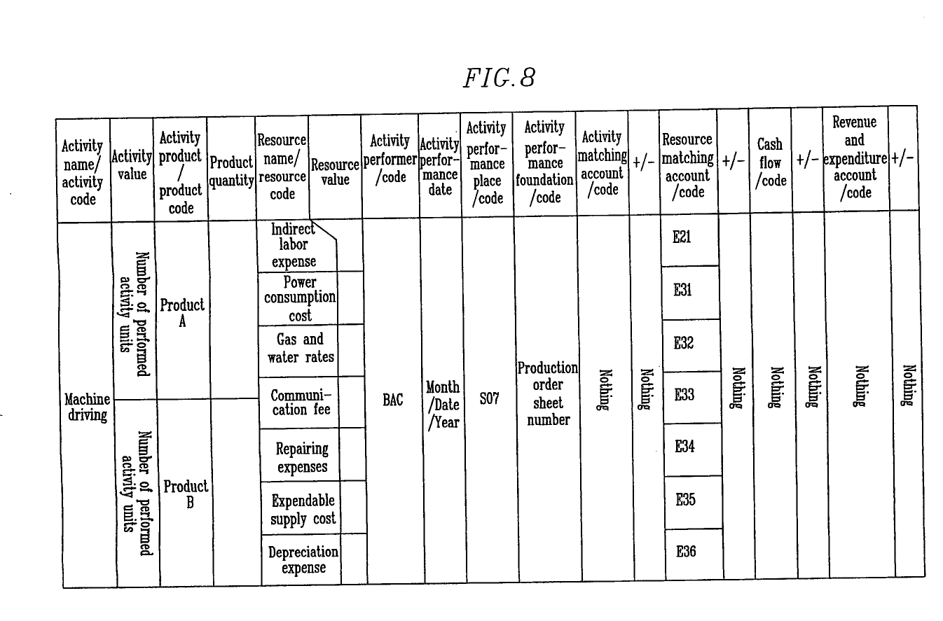

FIGS. 7(a) and 7(b) show exemplified activity information definition tables. When matching the activity names and the resource names with account names, the type 1 shown in FIG. 7(a) matches the activity names with the account names in the activity name group and the resource names with the account names in the resource name group, and the type 2 shown in FIG. 7(b) matches the activity names and the resource names with respect to classification of the account names including assets, debts, funds, profits, and expenditures, and both types have no difference in their essentials.

FIG. 8 shows an exemplified activity information definition table according to a preferred embodiment of the present invention, that is, a table for defining a machine driving activity from among internal activities.

Referring to FIG. 8, the activity information definition table includes an activity information component for completely recording the machine driving activity from among the internal activities, and an account of an external activity needed for calculating the price of the resource consumed by the machine driving activity.

Definition of the internal activities requires no expertise, and any person who knows what products the machine driving activity produces and what resources the machine driving activity consumes can define the internal activity in a commonsense manner.

In detail, in the internal activity of machine driving, the products A and B are produced, and resources including an indirect labor expense, power consumption cost, gas and water rates, communication fee, repairing expenses, expendable supply cost, and depreciation expense are exhausted for the products, and the accounts of the external activities matched with the respective consumed resources are respectively E21, E31, E32, E33, E34, E35, and E36, and accordingly, it is defined that the corresponding price is referred to from a database recorded at the generation of the external activity to calculate an activity price.

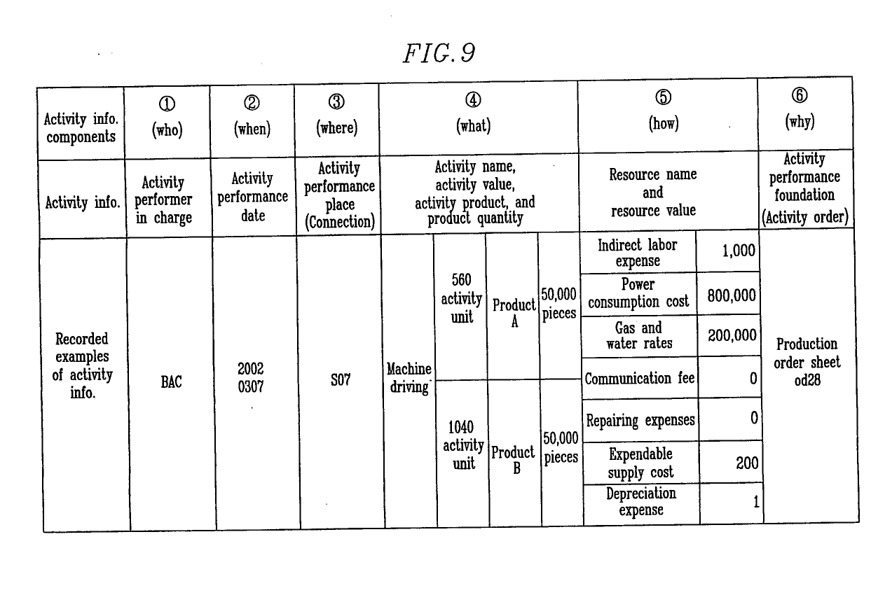

FIG. 9 shows an exemplar for recording activity information according to a preferred embodiment of the present invention, that is, activity information of a machine driving activity from among the internal activities, and this recording follows common sense and requires no specific expertise.

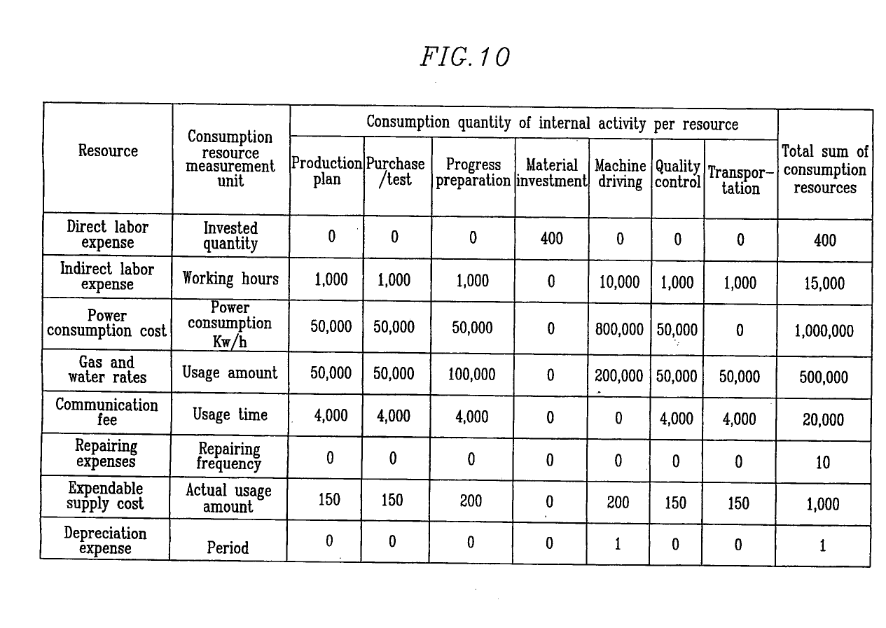

In the above-noted exemplar, it is assumed that the products A and B are respectively produced through the internal activities such as a production plan, purchase and examination, process preparation, quality control, and transportation in addition to the machine driving activity in the business organization, and the internal activities consume eight resources with direct cost of materials, and FIGS. 10 through 12 show an exemplified process for calculating the costs of products based on the above assumption.

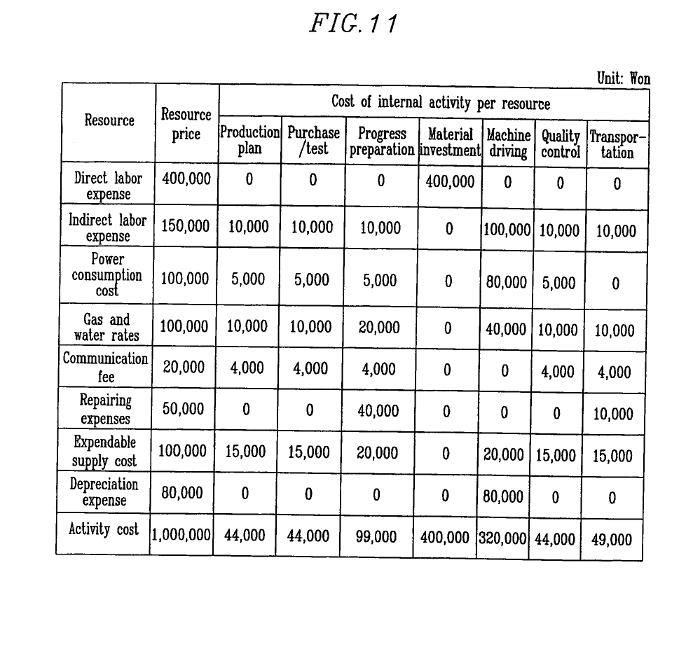

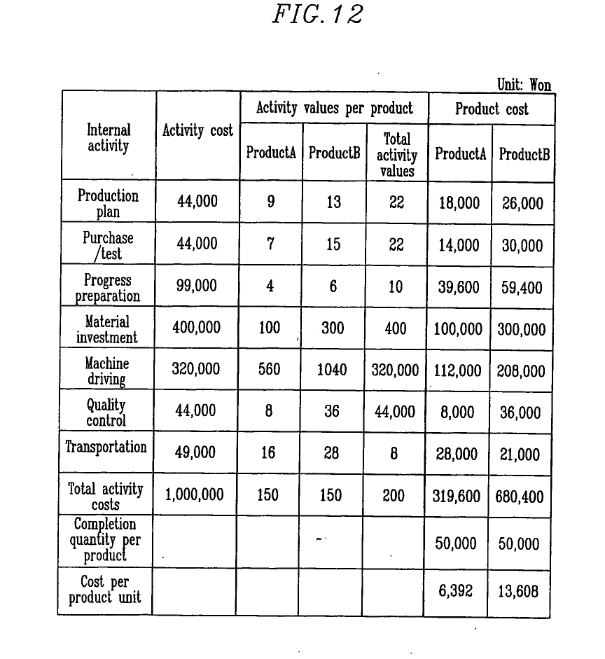

FIGS. 10 through 12 show an internal activity and cost accounting process according to a preferred embodiment of the present invention, FIG. 10 showing consumed quantities of the internal activities collected through a recording process of the activity information per resource, FIG. 11 showing a processing case for checking the price of each consumption resource for calculating the cost of the internal activity per resource, and FIG. 12 showing an exemplified case of the cost of the product according to the activity value for each product.

The activity information processing system 300 calculates the prices of the external and internal activities through the above-noted process, and concurrently provides various activity reports required by the business organization on the basis of the calculated information in step S380.

As described above, the activity information processing system 300 according to the embodiment of the present invention concurrently provides accounting reports and non-accounting reports through processing of the activity information database, including accounting information and non-accounting information, through a method of providing component-based reports of the activity information.

Also, the activity reports of the business organization according to the preferred embodiment of the present invention are provided for each component of the 5W1H rule, and various types of the activity reports are provided following combination of the components in many ways. Therefore, the various activity reports shown in FIG. 5 only show their exemplars. For ease of description in the preferred embodiment of the present invention, the activity reports of the business organization are classified as an activity achievement report, a resource report, and a report of the activity information per qualitative component.

First, the activity achievement report includes a product cost report, an income statement, a business value report, and a revenue and expenditure report. The product cost report is made by a method for calculating the price of the product caused by the internal activity using the price of the internal activity calculated through the step of S370.

The activity cost is allocated to each product according to the activity value for each product as shown in FIG. 12, to calculate a product cost and a cost per product unit.

The income statement is a report for displaying the business achievements of the business organization for a predetermined period in the profits and losses pattern. The income statement is made through a method for subtracting the price (a purchase activity value) of a purchase activity sacrificed for this from the price (a sale activity value) of the product of profit activities including sale, and it follows a common form generally used by the standard of business accounting.

The business value report fully reflects the profit concept of the economics, and since opportunity cost of the capital used for the profit are subtracted from the profit based on the cash flow, the net increase of the cash is calculated referring to information on the cash flow for each activity from the activity information database, and the capital cost and others are subtracted from the net increase of cash, and thereby making the business value report.

The revenue and expenditure settlement report is an accounting report used not by a company but by a governmental section from the business organization, and it is made by a method of recording the activities of the revenues and expenditures, it can also be concurrently made with other activity reports referring to the activity information database and the activity information definition table.

Other various activity reports in addition to the cost report are similar to the forms of the accounting reports generally used by business accounting standards or governmental budget accounting rules, and hence, they will not be exemplified. FIG. 13 shows a case of a business value report.

Since a direct cash flow statement is provided as one of the default activity reports concurrently with other activity reports without performing an additional report-making process, a business value report made based on the information on the cash flow can be immediately provided.

FIG. 13 shows an exemplified business value report made according to a preferred embodiment of the present invention.

The calculation components except the capital cost required for making the business value report are provided automatically through a process for recording activity information. In the preferred embodiment of the present invention, the process for calculating the capital cost is not included, and the capital cost calculated from other processes is used and applied.

In addition, as to making the business value report in the preferred embodiment of the present invention, the most important component in making the business value report, that is, the information on the cash flow, can be immediately provided.

Next, the resource report includes a balance sheet and a cash flow statement. The balance sheet is a statement of financial condition of the business organization at a given date, and the balance sheet is made through a method of writing the resources supplied by the activities on one side and recording activities that are supply sources thereof on the other side since currently-possessed resources of the business organization and information on their supply sources are needed so as to check the financial state, and the corresponding forms follow the forms that are generally used by the business accounting standard.

Further, the balance sheet is also referred to as a financial statement. In addition to the balance principle that is the conventional journalizing accounting principle which adopts a debtor and a creditor, the sum of the supplied resources which are recorded on one side of the balance sheet and the sum of the sources that are recorded on the other side of the balance sheet are to be matched on the basis of the definition that the price of the resources possessed by the business organization and the price of the activities that are sources for resource supply coincide with each other.

The cash flow statement is a report for providing information on cash inflow and outflow for a predetermined time. A direct cash flow statement is made through a method of directly arranging the cash flow per activity that accompanies cash flow, and an indirect cash flow statement is made through a method of adding or subtracting accounts with no inflow or outflow of cash from the net profit of this term. Their form follows the form of the cash flow statement generally used by the business accounting standard.

The preferred embodiment of the present invention is characterized in that the direct and indirect cash flow statements are concurrently produced as a basic activity report by only recording the components of the activities according to the 5W1H rule.

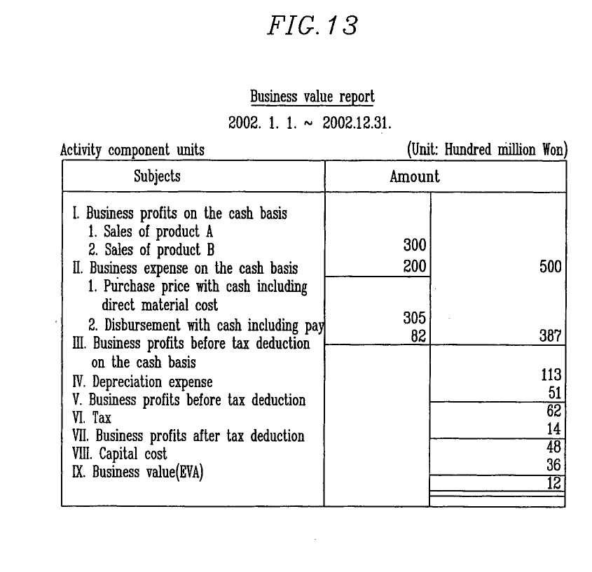

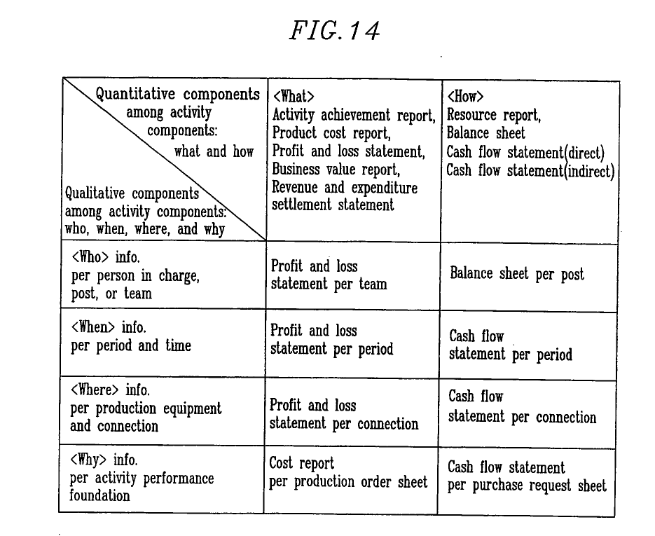

The above-noted activity achievement report and resource report can be made on the overall level of the business organization, and they can also be made for the respective components of the activity information, as shown in FIG. 14.

Next, in addition to the quantitative activity reports focusing on the price as described above, qualitative activity reports can also be made which include a personal resume report for reporting a history on the activities executed by each individual of the business organization, a stock receipt and payment report for reporting information on the incomes and outgoes of products in stock, a production completion report for reporting production activities, and a delivery report per order sheet as shown in the steps S396 through S399 of FIG. 5.

The present invention relates to an activity information processing method without requiring additional learning for processing the activity information, but the activity information processing method according to the preferred embodiment of the present invention may be inconvenient to persons in charge and accounting experts who are familiar with the conventional journalizing accounting or the activity accounting method until they are skilled in the activity information processing method. For them, it may be realistically required to provide the conventional accounting processing method and the activity accounting processing method, and allow the user to further input activity information needed by the activity information processing according to the preferred embodiment of the present invention.

To satisfy the realistic requirement, the activity information processing system according to the preferred embodiment of the present invention discloses a method for additionally inputting activity information matched with the 5W1H rule to the conventional journalizing accounting processing method and the activity accounting processing method.

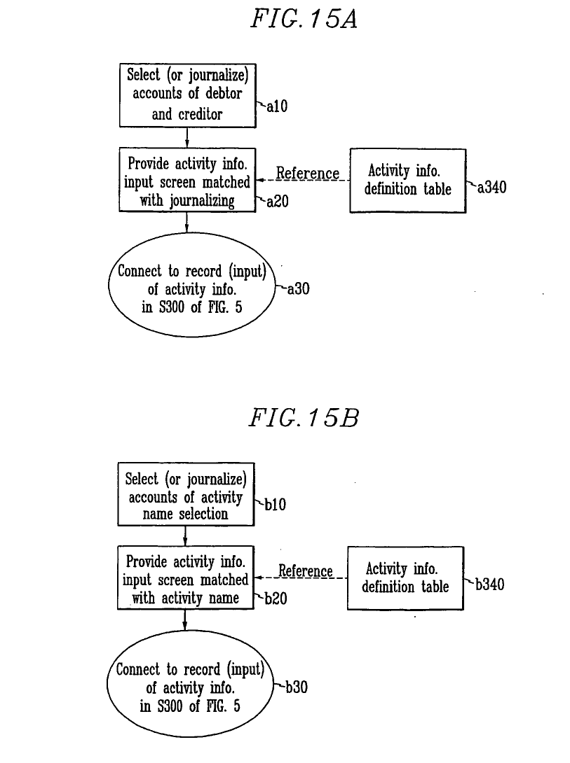

FIGS. 15(a) and 15(b) show flowcharts of an activity information input process according to input methods when processing the journalizing or activity accounting in the conventional information system divided into an accounting system and a non-accounting system.

FIG. 15(a) shows the type 1, and when information on account items of the debtor and the creditor is input according to the conventional journalizing accounting processing method in step a10, a predefined activity information definition table is referenced to display an activity information input screen corresponding to the journalizing in step a20. FIG. 15(b) shows the type 2, and when an activity name is selected according to the conventional activity accounting processing method in step b10, the activity information definition table is referenced to display an activity information input screen corresponding to the activity name in step b20.

In this instance, the process for referencing the activity information definition table and displaying an additionally needed activity information input screen will now be described in detail.

In the case of type 1, when account item information corresponding to the debtor and the creditor is input according to the conventional journalizing accounting processing method in step a10, the activity information processing system reads an activity matching account and a resource matching account included in the type 1 of the activity information definition table corresponding to the account item information or asset and cost account and an liabilities, funds and profit account included in the type 2, and provides, through an input screen, remaining activity information which is not matched with the account item information and not input in step a20.

After this, when the user inputs remaining information except the information matched with the account to the displayed input screen, the subsequent process is executed in the same manner of the process after the step S300 of the activity information processing system of FIG. 5 in step a30, which will now be described through a detailed exemplar.

For example, on the assumption that a product A is sold for one million Won, 600,000 Won is received in cash, and 400,000 Won is left on credit, when performing an accounting process on this transaction according to the conventional journalizing accounting processing method, subsequent transaction information is input that is account item information matched with the debtor and the creditor journalized by the conventional journalizing accounting processing method in the step a10.
(Debtor) Cash 600,000 Won (Creditor) Sale 1,000,000 Won
Account Receivable 400,000 Won

Information on the debtor and the creditor input through the above-noted journalizing does not fully include activity information desired by the embodiment of the present invention. In order to allow the user to additionally input the rest of the activity information required by the embodiment of the present invention, an activity information definition table is provided in step S340, which will now be described by using the activity information definition table of FIGS. 7(a), 7(b), and 8.

The journalizing information on the debtor and the creditor shows the accounts generated by transactions in the form of matching the debtor with the creditor, and the respective accounts correspond to the activity matching account and the resource matching account of FIG. 7(a) or a predetermined account of the asset and cost account or the liabilities, funds, and profit account of FIG. 7(b).

As shown in FIG. 15(a), it is checked to which activity the input journalizing information corresponds by referring to the activity information definition table a340 shown in FIG. 7(a) or 7(b), and an activity information input screen corresponding to the journalizing is provided to the user in step a20.

In the above-exemplified case, through the process of referring to the activity information definition table of FIG. 7(a) or 7(b), the sale account is matched with the sale activity, the cash and the account receivable accounts are respectively matched with the cash and the account receivable resource, the corresponding activity value is 1,000,000 Won, and the resource values are 600,000 Won (cash) and 400,000 Won (account receivable).

However, when the accounting information is input through journalizing, only the information matched with the account of FIG. 7(a) or 7(b) is input, and the rest of contents of the activity information definition table except the account in FIG. 7(a) or 7(b), such as a product quantity, an activity performer, an activity performance date, an activity performance place, an activity performance foundation, and information of FIG. 8 that corresponds to the internal activity information are not input, and in the preferred embodiment of the present invention, the rest of the contents are displayed on the input screen so that the user may additionally input them in step a20.

In the case of type 2, when information matched with the activity name is input according to the conventional activity accounting processing method in step b10, the activity information processing system reads activity names included in one of the type 1 and type 2 activity information definition tables, and displays the rest of the corresponding activity information that is not input in step b20.

After this, when the user inputs remaining information except the information matched with the account to the displayed input screen, the subsequent process is performed in the same manner as the process after the step S300 of the activity information processing system of FIG. 5 in step b30, which will now be described in detail.

For example, on the assumption that a product A is sold for one million Won, 600,000 Won is received in cash, and 400,000 Won is left on credit, when performing an accounting process on this transaction according to the conventional activity accounting processing method, subsequent transaction information is input that is activity information matched with the activity and the resource input by the conventional activity accounting processing method in the step b10.
(Activity) Sale 1,000,000 Won (Resource) Cash 600,000 Won
Account receivable 400,000 Won

Information on the activity and the resource input through the above-noted activity accounting process does not fully include activity information desired by the embodiment of the present invention. In order to allow the user to additionally input the rest of the activity information required by the embodiment of the present invention, an activity information definition table is provided in step S340, which will now be described by using the activity information definition table of FIGS. 7(a), 7(b), and 8.

The activity information on the activity and the resource shows the accounts generated by transactions in the form of matching the activity with the resource, each of which is matched with a predetermined activity or a resource of FIG. 7(a) or 7(b).

As shown in FIG. 15(b), it is checked to which activity the input activity information corresponds by referring to the activity information definition table b340 shown in FIG. 7(a) or 7(b), and an activity information input screen corresponding to the activity is provided to the user in step b20.

In the above-exemplified case, through the process of referring to the activity information definition table of FIG. 7(a) or 7(b), the sale activity is matched with the sale account, the cash and the account receivable resources are respectively matched with the cash and the account receivable accounts, the corresponding activity value is 1,000,000 Won, and the resource values are 600,000 Won (cash) and 400,000 Won (account receivable).

However, when the accounting information is input through the activity accounting processing method, only the information matched with the account code of FIG. 7(a) or 7(b) is input, and the rest of the contents of the activity information definition table except the account code in FIG. 7(a) or 7(b), such as a product quantity, an activity performer, an activity performance date, an activity performance place, an activity performance foundation, and information of FIG. 8 that corresponds to the internal activity information are not input, and in the preferred embodiment of the present invention, the rest of the contents are displayed on the input screen so that the user may additionally input them in step b20.

Also, since the preferred embodiment uses a processing method different from the conventional business information processing method, it may be impossible to utilize various data output from the conventional journalizing or activity accounting system in the case of adopting the activity information processing method according to the preferred embodiment of the present invention. Since the activity information attaches much importance to comparison possibility, it is needed to add activity information necessary for the conventional data for the comparison possibility between the data of the conventional journalizing or activity accounting processing method and the data of the activity information processing method of the preferred embodiment of the present invention.

Therefore, in order to obtain the comparison possibility of the data between the conventional journalizing or activity accounting processing method and the data of the activity information processing method, it is required to combine the accounting data and the non-accounting data separated and processed from the conventional journalizing or activity accounting processing method, and add additional activity information from among activity information following the 5W1H rule desired by the activity information of the present invention.

To satisfy the above-noted needs, the preferred embodiment of the is present invention discloses a method for combining the accounting information and the non-accounting information following the conventional journalizing or activity accounting processing method and adding activity information.

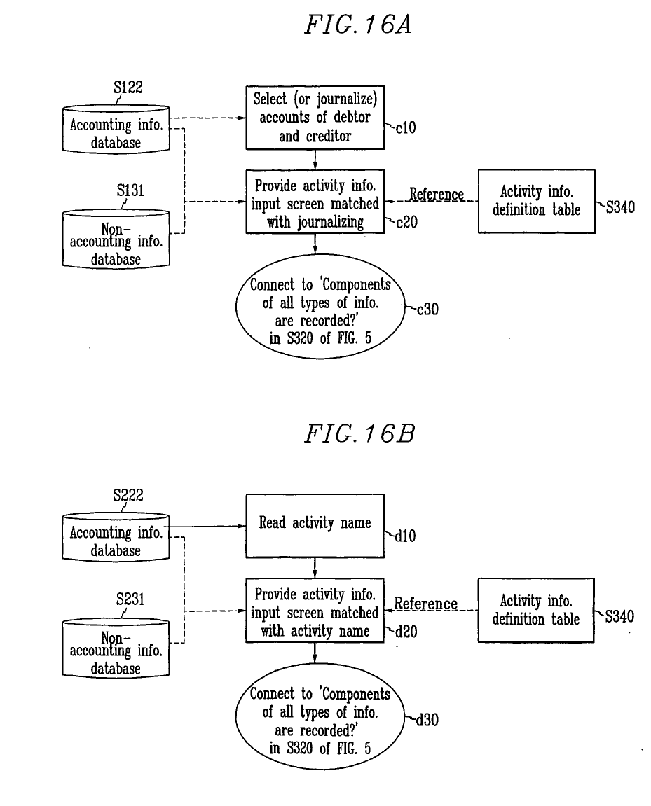

FIGS. 16(a) and 16(b) show a process for converting externally input journalizing or activity accounting data in the conventional information system, divided into an accounting system and a non-accounting system, into activity information data according to a preferred embodiment of the present invention.

As to the type 1 of FIG. 16(a), in order to add complete activity information to the data caused by the conventional journalizing accounting processing method, account items of the debtor and the creditor are read from an accounting processing data stored in the conventional accounting information database S122 in step c10, and the predefined activity information definition table is referred to check what types of activity information matched with journalizing are provided.

After this, the non-accounting information database of the conventional journalizing accounting system receives corresponding activity information in step c20, performs the process after the step S320 of FIG. 5, needed activity information is added if necessary, and the activity information is processed in step c30.

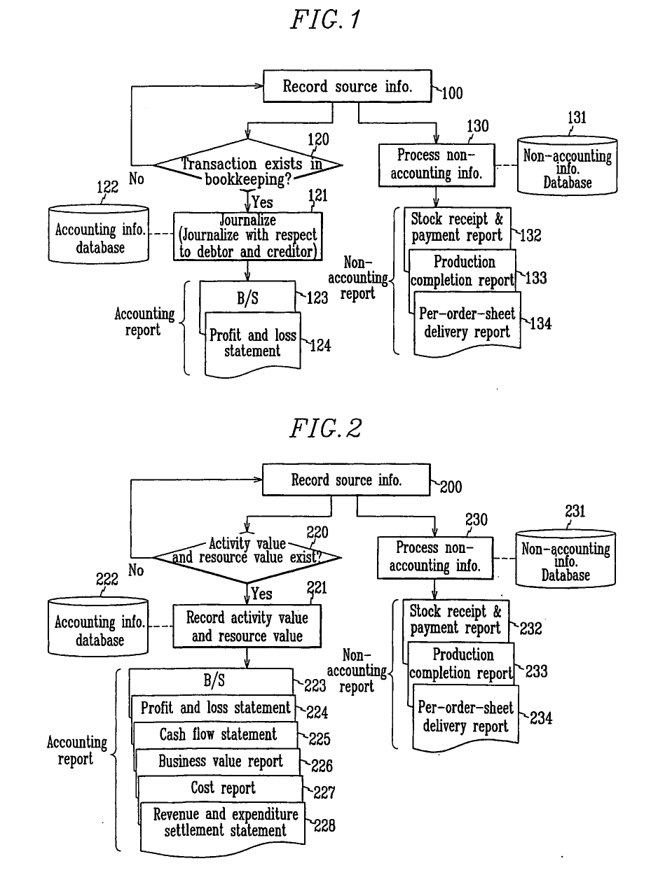

In further detail, information on the account items matched with the debtor and the creditor input through the conventional journalizing accounting processing method is read from the accounting information database (S122 of FIG. 1: a database for storing information on the debtor and the creditor) in step c10, an activity matching account and a resource matching account included in the type 1 of the corresponding activity information definition table S340 or an asset and cost account and a liabilities, funds, and profit account included in the type 2 are referred to, and the corresponding remaining activity information which is not input is received from the non-accounting information database (S131: a database for storing information except information on the debtor and the creditor) from the conventional journalizing accounting processing method in step c20. When the activity information is insufficient, the process after the step S320 of FIG. 5 is performed to add additional activity information and perform an activity information process in step c30.

For reference, accounting information and non-accounting information are separated, processed, and managed in the journalizing accounting processing method from among the conventional accounting processing methods as shown in FIG. 16(a), and the accounting information and the non-accounting information are concurrently processed and then managed through a single database in the conventional activity accounting processing method. In the preferred embodiment of the present invention, respective databases are separately described for conceptual explanation as shown in FIG. 16(b).

Next, the type 2 of FIG. 16(b) combines the accounting data and the non-accounting data caused by the conventional activity accounting processing method, and adds additional activity information.

In order to add complete activity information to the data generated by the conventional activity accounting processing method, the activity name is read from the accounting processing data stored in the conventional accounting information database in step d10, and the predefined activity information definition table is referred to to check what activity information corresponds to the activity name.

After this, corresponding activity information is received from the non-accounting information database (S222 of FIG. 2) of the conventional activity accounting system in step d20, and the process after the step S320 of FIG. 5 is performed to add additional activity information if needed, and perform the activity information process in step d30.

In detail, information matched with the activity name input by the conventional activity accounting processing method is read from the accounting information database in step d10, the activity name included in the type 1 or type 2 of the corresponding activity information definition table is referred to, and the corresponding remaining activity information which is not input is received from the non-accounting information database (S231 of FIG. 2: a database for storing information except information on the activity value and the resource value) input by the conventional activity accounting processing method in step d20. When the activity information is insufficient after this receipt, the process after the step S320 of FIG. 5 is performed to add additional activity information and perform the activity information process in step d30.

When the activity information is added through the above method, the accounting process after the step S350 is performed regarding the activity information to provide various accounting reports.

The above-described activity information processing method is performed by the activity information processing system including an individual computer system as shown in FIG. 3, and further, the method can be performed by an activity information processing system using a network such as the LAN or the Internet, which will now be described.

Referring to a drawing, a second preferred embodiment of the present invention will be described.

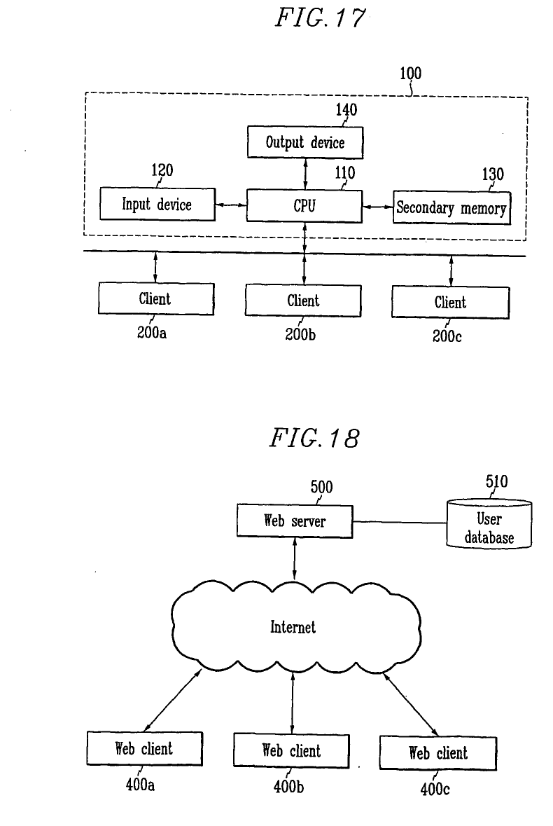

FIG. 17 shows a configuration of an activity information processing system in a business organization according to a second preferred embodiment of the present invention.

As shown, the activity information processing system according to the second preferred embodiment of the present invention comprises an activity information processing server 100 and a plurality of clients 200a, 200b, 200c and others.

When the user inputs activity information of the business organization through the clients 200a, 200b, and 200c, the activity information processing server 100 performs the activity information process on the input activity information in the same manner of the previously described activity information processing method, and it comprises a CPU (central processing unit) 110, an input device 120, a secondary memory 130, and an output device 140.

As described above, the CPU 110 reads and executes program instructions for performing an activity information processing method, the input device 120 is used to externally input data required for manipulation of the activity information processing server 100, and the output device 140 outputs data processing results according to the activity information processing method.

The secondary memory 130 stores a program for executing an activity information processing method, and results of the activity information processing method in a predetermined file format.

The clients 200a, 200b, and 200c are provided for each one's post. When a predetermined activity of the business organization occurs in each post, the user uses the clients to input business activity information. In this instance, the clients 200a, 200b, and 200c can be wire or wirelessly connected to the activity information processing server 100.

Since the operation of the activity information processing system according to the second preferred embodiment of the present invention is almost identical with the previously described activity information processing method except that the activity information of the business organization is input through the clients 200a, 200b, and 200c, and the input activity information is processed by the activity information processing server 100, no repeated description will be provided.

Next, FIG. 18 shows a configuration of an activity information processing system in a business organization according to a third preferred embodiment of the present invention.

Referring to FIG. 18, the activity information processing system according to the third preferred embodiment of the present invention comprises a web server 500, a user database 510, and a plurality of web clients 400a, 400b, and 400c.

When the user inputs activity information on the business organization through the respective web clients 400a, 400b, and 400c, the web server 500 transmits activity information processing results to the web clients 400a, 400b, and 400c in the like manner of the previously-described activity information processing method. The user database 510 stores user information including user IDs and passwords, and each user's activity information.

The web clients 400a, 400b, and 400c represent computers through which respective users (a business organization) access the web server 500 on the Internet. That is, each user uses his web client to access the web server 500 when a predetermined activity has occurred, and the user inputs activity information of the business organization. The web server 500 then checks the input ID and a password of the user, and outputs results matched with each user's input contents to the web client.

An operation of the activity information processing system according to the third preferred embodiment of the present invention will now be described.

When an activity of the business organization occurs, the user accesses the web server 500 through the web clients 400a, 400b, and 400c, and inputs user information including an ID and a password. The web server 500 checks whether the input user information is matched with the contents stored in the user database 510, and when they are matched, it outputs an activity including an activity type including one of a purchase and acquisition activity, a sale and income activity, an expense activity, an investment and financial activity, a production activity (internal activities), a closing activity, a revenue activity, an expenditure activity, and an administration service providing activity (internal activities) to the web clients 400a, 400b, and 400c.

The user selects to which activity type the activity of the business organization corresponds, and inputs detailed activity information on the selected activity type through the web clients 400a, 400b, and 400c. The web server 500 processes the input activity information according to the above-described activity information processing method, stores processed results to the user database 510, and concurrently transmits them to the corresponding client.

According to the preferred embodiments of the present invention, ordinary persons who are not experts and have no accounting expertise can output necessary activity reports by inputting activity information of the business organization without performing an additional accounting process executed by journalizing accounting or activity accounting.

Also, by inputting activity information of the business organization, accounting reports including a product cost report, a business value report, a revenue and expenditure settlement statement, and a cash flow statement in addition to a balance sheet and a profit and loss statement, and various non-accounting reports including a personal resume report, a stock receipt and payment report, a production completion report, and a per-order-sheet delivery report can be concurrently provided.

The activity information processing system and method according to the present invention concurrently and in real-time provides various activity reports including accounting reports and non-accounting reports on the activities of the business organization that lead the organization using economic resources.

Further, since the activity reports of the business organization can be provided through a single procedure of a single system, and the externally input journalizing or activity information input method is used as it is, the present invention can provide convenient activity information processing services to the users who are familiar with the conventional accounting process. Also, by converting the accounting data processed by the conventional journalizing or activity accounting processing system into an activity information data format following the present invention, the continuity of activity information is maintained.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A method for processing activity information of a business organization using a data processing system for storing an activity information definition table matched with activity information and making an activity report based on input activity information and a corresponding account of the activity report, comprising:
(a) respectively displaying a plurality of activity types respectively defining an activity history of the business organization;
(b) receiving a selection of at least one activity type of the displayed activity types from a user;
(c) displaying a configuration screen corresponding to “what” and “how” of the activity type so as to input activity information on the selected activity type;
(d) using the activity information input by the user and the activity information definition table, and processing activity information; and
(e) using the processed activity information and providing an activity report on the activity of the business organization.

2. The method of claim 1, wherein (c) comprises displaying a configuration screen of the 5E1H rule additionally including “who,” “when,” “where,” and “why” of the activity type.

3. The method of claim 1, wherein (a) comprises respectively * displaying activity types including at least one of a purchase and acquisition activity, a sale and income activity, an expense activity, and a production activity of the business organization.

4. The method of claim 1, wherein (a) comprises respectively displaying activity types including at least one of a revenue activity, an expenditure activity, and an administration service providing activity of the business organization.

5. The method of claim 1, wherein (d) comprises:
determining whether the input activity information is an internal activity or an external activity;
determining whether the total of activity values for representing worth of the activities from among the input activity information and the total of resource values for representing worth of the resources that enables the activities are matched, when the activity information is an external activity; and
using the activity information definition table and the input activity information and making an activity report of the business organization, when the total of the activity values and the total of the resource values are matched.

6. The method of claim 5, wherein (d) further comprises outputting to the user a message for allowing input again of activity information, when the total of the activity values and the total of the resource values are different.

7. The method of claim 6, wherein (d) comprises:
referring to the activity information definition table and checking an external activity product matched with the resource used for the internal activity, when the input activity information is an internal activity; and
using the checked external activity product and calculating the price corresponding to the resource used for the internal activity.

8. The method of claim 7, wherein (e) comprises:
making an accounting report on the business organization based on the calculated price; and
making a non-accounting report on the business organization based on the calculated price, and wherein the activity report of the business organization is made for each component of the activity information.

9. The method of claim 8, wherein making an accounting report comprises:
making a component-based activity achievement report including at least one of a product and service cost report, a profit-and loss statement, a business value report, and a revenue and expenditure settlement statement; and
making a component-based resource report including at least one of a balance sheet and a cash flow statement.

10. The method of claim 8, wherein the making a non-accounting report comprises: making a component-based report including at least one of a personal resume report, a stock receipt and payment report, a production completion report, and a per-order-sheet delivery report.

11. The method of claim 1, further comprising:
referring to the activity information definition table and displaying an activity information input screen matched with account items of the debtor and the creditor of the business organization, when information on the account items of the debtor and the creditor of the business organization is externally input; and
displaying an additional activity information input screen except the displayed activity information when additional activity information is needed.

12. The method of claim 1, further comprising:
referring to the activity information definition table and displaying an activity information input screen matched with an activity name of the business organization, when information on the activity name of the business organization is externally input; and
displaying an additional activity information input screen except the displayed activity information when additional activity information is needed.

13. A method for processing activity information of a business organization using a data processing system for making an activity report based on activity information extracted from a first database and a second database, and an account of an activity report corresponding to the activity information, the first database storing an activity information definition table matched with activity information of the business organization and managing information on accounting of the business organization, the second database managing information on non-accounting aspects of the business organization, comprising:
(a) extracting account item information matched with the debtor and the creditor of the business organization from the first database, referring to the activity information definition table, and acquiring first activity information matched with the extracted information;
(b) extracting information matched with additional activity information except the first activity information from the second database, referring to the activity information definition table, and acquiring second activity information matched with the extracted information;
(c) combining the acquired first and second activity information, using the combined activity information and the activity information definition table, and processing activity information; and
(d) using the processed activity information, and providing an activity report on the activity of the business organization.

14. The method of claim 13, further comprising:
extracting information matched with an activity name of the business organization from the first database, referring to the activity information definition table, and acquiring third activity information matched with the extracted information; and
extracting information matched with additional activity information except the third activity information from the second database, referring to the activity information definition table, and acquiring fourth activity information matched with the extracted information.

15. The method of claim 13, wherein (c) comprises determining whether the combined activity information is an internal activity or an external activity.

16. An activity information processing system comprising:
a secondary memory for storing an activity information definition table matched with activity information of a business organization, and storing an activity information processing program and activity information processing results, the activity information processing program processing activity information based on a connection relation between the input activity information and a corresponding activity report;
an output device for outputting a plurality of activity types for respectively defining an activity history of the business organization so that a user may select at least one of the output activity types, and outputting a configuration screen matched with “what” and “how” of the activity types so that activity information on the selected activity type may be input; and
a CPU (central processing unit) for using the stored activity information definition table, and providing an activity report on the activity of the business organization.

17. The system of claim 16, wherein the output device outputs a configuration screen of the 5W1H rule additionally including “who,” “when,” “where,” and “why” of the activity types.

18. The system of claim 16, wherein the CPU executes the activity information processing program to determine whether activity information of the input activity type is an internal activity or an external activity.

19. The system of claim 18, wherein the output device respectively outputs activity types including at least one of a purchase and acquisition activity, a sale and income activity, an expense activity, a production activity, and an administration service providing activity of the business organization.

20. The system of claim 19, wherein the output device respectively outputs activity types additionally including at least one of a revenue activity and an expenditure activity.

21. The system of claim 16, wherein the CPU refers to an account in the activity information definition table matched with journalizing information and makes an activity report on the journalizing information when the input activity information is the journalizing information including the debtor and the creditor of the business organization, and the CPU externally receives additional activity information or adds the same when the input activity information is insufficient at the time of generating the activity report.

22. The system of claim 21, wherein the CPU refers to an activity name in the activity information definition table matched with the activity information and makes an activity report on the activity information when the input activity information is an activity information related to an activity name of the business organization, and the CPU externally receives additional activity information or adds the same when the input activity information is insufficient at the time of generating the activity report.

23. The system of claim 22, wherein the CPU generates accounting reports including: a component-based activity achievement report including at least one of a product and service cost report, a profit and loss statement, a business value report, and a revenue and expenditure settlement statement of the business organization; and a component-based resource report including at least one of a balance sheet and a cash flow statement.

24. The system of claim 23, wherein the CPU generates non-accounting reports including at least one of a personal resume report, a stock receipt and payment report, a production completion report, and a per-order-sheet delivery report.

25. The system of claim 16, wherein the activity information is input through a client provided at each post.

26. The system of claim 16, wherein a web client inputs the activity information through the Internet.

27. The system of claim 16, further comprising: a user database for storing user information including user IDs and passwords, and each user's accounting information.
